(19) United States
(12) Patent Application Publication
(10) Pub. No.: US 2013/0262231 A1
(43) Pub. Date: Oct. 3, 2013

(54) TARGETED INCENTIVE ACTIONS BASED ON THE NUMBER OF PEOPLE WITHIN A GEOGRAPHIC LOCALE

(71) Applicants: Dane Glasgow, Los Altos, CA (US); Jack Phillip Abraham, Palo Alto, CA (US); Jonathan Conradt, San Jose, CA (US); Shannon B. Vosseller, San Francisco, CA (US)

(72) Inventors: Dane Glasgow, Los Altos, CA (US); Jack Phillip Abraham, Palo Alto, CA (US); Jonathan Conradt, San Jose, CA (US); Shannon B. Vosseller, San Francisco, CA (US)

(73) Assignee: eBay Inc., San Jose, CA (US)

(21) Appl. No.: 13/436,370

(22) Filed: Mar. 30, 2012

(51) Int. Cl. G06Q 30/02

(52) U.S. Cl. 705/14.58

(57) ABSTRACT

Offering an incentive to users of a mobile device based on the number of devices within a geographic locale. The incentive may be one or more incentives that a merchant is willing to offer only if there are a given number of users within a geographic locale. The incentive may be combined with additional incentives determined in various ways. A location identification module may determine the geographic location of mobile devices. An item identification module may identify that a merchant may be willing to offer an incentive only if there are a given number of users within a geographic locale and may identify an item specified by one or more of the given number of users within the geographic locale. An incentive module may transmit an incentive from a merchant who may or may not be within the geographic locale.

### TECHNICAL FIELD

This application relates to a method and system for determining targeted incentives based on a user location and activity.

### BACKGROUND

With the advent of sophisticated mobile devices and the global positioning system, instant access to information that indicates the location of cell phones or other devices, or the number of cell phones or other devices within a given geographic locale, is available. For example, a business may be able to subscribe to a service that will provide an indication of the number of cell phones in a given geographic locale.

### BRIEF DESCRIPTION OF THE DRAWINGS

The present embodiments are illustrated by way of example, and not by way of limitation, in the figures of the accompanying drawings in which:

FIG. 1 is a network diagram depicting a networked system, according to one embodiment, having a client-server architecture configured for exchanging data over a network;

FIG. 2 is a block diagram illustrating an example embodiment of a location-based incentive application;

FIG. 3 is a block diagram illustrating an example embodiment of a location identification module;

FIG. 4 is a block diagram illustrating an example embodiment of an item identification module;

FIG. 5 is a block diagram illustrating an example embodiment of an incentive module;

FIG. 6 is a block diagram illustrating an example of attributes of a data structure for an incentive;

FIG. 7A is a simplified diagram illustrating a global positioning system (GPS) locating system.

FIG. 7B is a logic diagram useful in determining the number of devices within a given geographic locale.

FIG. 7C illustrates an apparatus useful in determining the number of devices in a given geometrical local.

FIG. 8 is a flow chart of an example method for identifying that a given number of devices is located within a given geographic area;

FIG. 9 shows a diagrammatic representation of machine in the example form of a computer system within which a set of instructions may be executed to cause the machine to perform any one or more of the methodologies discussed herein.

### DETAILED DESCRIPTION

Although the present embodiments have been described with reference to specific example embodiments, it will be evident that various modifications and changes may be made to these embodiments without departing from the broader spirit and scope of the embodiments. Accordingly, the specification and drawings are to be regarded in an illustrative rather than a restrictive sense.

In various embodiments, a method and a system may offer an incentive to operators of mobile devices and in some cases non-mobile devices, based on the number of devices (and, implicitly, the number of users) located within a geographic locale. The number of devices within a locale, which may be the area traced by fully rotating a fixed radius of a given circle or the designated area of another geometric shape, based on geographic locale, is determined. The number of devices within such an area is counted, for example, by counting each device as it enters the area. For desired precision, the number of devices leaving the area may be counted and subtracted from the foregoing number. When the number of devices within the area reaches a particular number, a merchant, or party acting on the merchant's behalf, may activate an incentive, sometimes referred to herein as a “deal,” via GPS or other suitable technology, on the devices within the area. Incentives include and are not limited to promotions, discounts, sales, rebates, and coupons. In another embodiment, the incentive may be based on the combination of both the number of devices within the locale, and also on items identified on the devices. That is, the incentive may also be based on the number of devices within the locale and on the intent of the user as expressed by the requests received from the user that result in the items that are identified on the devices. Determining the intent of the user and determining incentives may be as set forth in U.S. patent application Ser. No. 13/050,769 entitled TARGETED INCENTIVE ACTIONS BASED ON LOCATION AND INTENT, assigned to the assignee of this patent and incorporated herein in its entirety

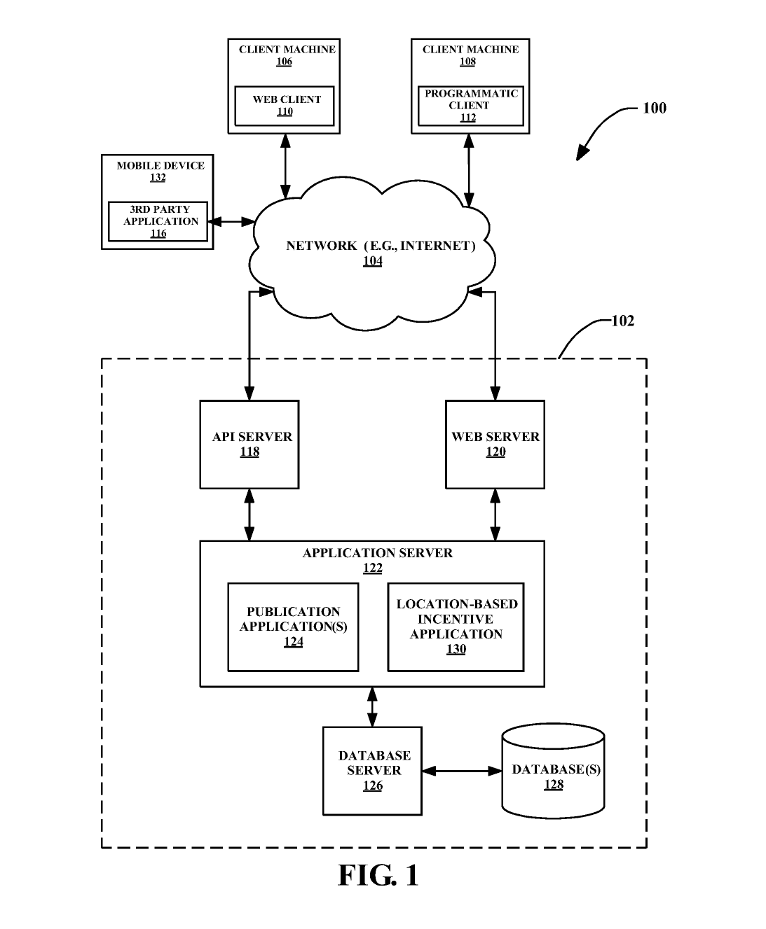

FIG. 1 is a network diagram depicting a networked or network based system 100, according to one embodiment, having a client-server architecture configured for exchanging data over a network 104. For example, the network system 100 may include a network-based publisher 102 where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet) to one or more clients. The one or more clients may include users that utilize the network system 100 and more specifically, the network-based publisher 102, to exchange data over the network 104. These transactions may include transmitting, receiving (communicating) and processing data to, from, and regarding content and users of the network system 100. The data may include, but are not limited to, content and user data such as feedback data; user reputation values; user profiles; user attributes; product and service reviews and information, such as pricing and descriptive information; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server or a mobile device 132 hosting a third party application 116. It can be appreciated in various embodiments the client machine 106, 108, or third party application 116 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

A mobile device 132 may also be in communication with the network-based publisher 102 via a web server 120. The mobile device 132 may include a portable electronic device providing at least some of the functionalities of the client machines 106 and 108. The mobile device 132 may include a third party application 116 (or a web client 110) configured to communicate with application server 122. Although only one mobile device 132 is shown, it will be appreciated that in practice there may be many mobile devices 132. That is, as used herein, the term “mobile device 132” may include plural mobile devices 132, depending on context. In some instances herein, the mobile device 132 may be referred to as a “user device.” Further, as is well known in the art, the mobile devices 132, and non-mobile devices as well, may be in contact with a GPS (global positioning system) or other suitable technology for determining the location of such devices and the incentives may be based on both the number of mobile devices 132 and non-mobile devices within the geographic locale.

Turning specifically to the network-based publisher 102, an application program interface (API) server 118 and a web server 120 are coupled to, and provide programmatic and web interfaces respectively to, one or more application servers 122. The application servers 122 host one or more publication application (s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., programmatic client 112 or third party application 116) running on another client machine (e.g., client machine 108 or a third party server).

The publication application(s) 124 may provide a number of publisher functions and services (e.g., listing, payment, etc.) to users that access the network-based publisher 102. For example, the publication application(s) 124 may provide a number of services and functions to users for listing goods and/or services for sale, facilitating transactions, and reviewing and providing feedback about transactions and associated users.

FIG. 1 also illustrates a third party application 116 that may execute on a third party server and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

The network-based publisher 102 may provide a multitude of feedback, reputation, aggregation, and listing and price-setting mechanisms whereby a user may be a seller or buyer who lists or buys goods and/or services (e.g., for sale) published by the network-based publisher 102.

The application server 122 also includes a location-based incentive application 130. The location-based incentive application 130 communicates incentives to the mobile device 132, and in some instances to other devices as well, based on the number of devices within the geographic locale and, in some embodiments, the intent of the user of the devices as well, as further described below.

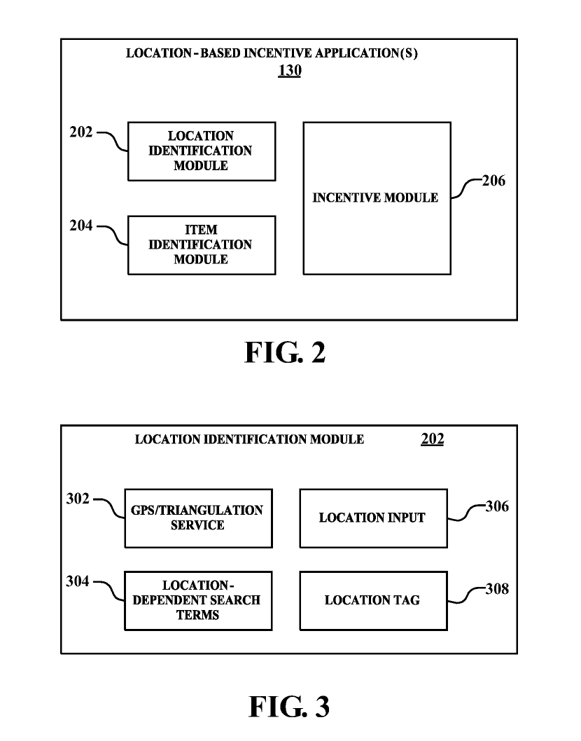

FIG. 2 is a block diagram illustrating an example embodiment of a location-based incentive application 130, which is provided as part of the network-based publisher 102 illustrated in FIG. 1. The location-based incentive application 130 includes a location identification module 202, an item identification module 204, and an incentive module 206. The location identification module 202 may determine a geographic locale of the mobile device 132 and, in some instances, other devices as well. In some instances, the location identification module 202, or parts thereof, may be located at a separate GPS, or other suitable location identification, service provider. The item identification module 204 identifies an item specified by the user of the mobile device 132 within the geographic locale. The incentive module 206 communicates an incentive from one or more merchants based on the identified item and the geographic locale of the mobile device 132. While local merchants and local databases are described herein, one of ordinary skill in the art will understand that merchants and databases that are non-local to the geographic locale may, in some instances, also be used. In general, the modules described may be implemented in hardware, firmware, or any combination thereof. Further, the incentive may be based solely or partly on a given item the merchant determines to be justified if there are at least a predetermined number of users within the given geographic locale.

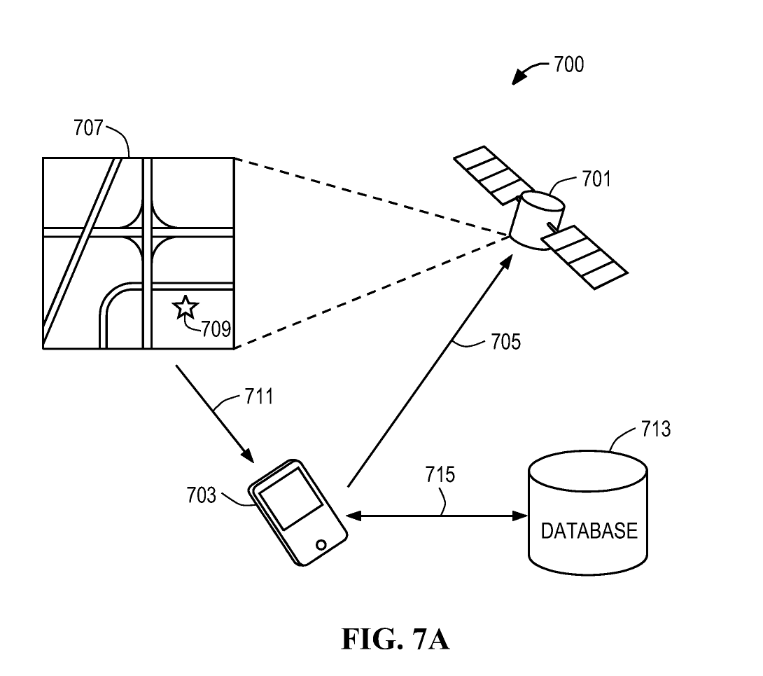

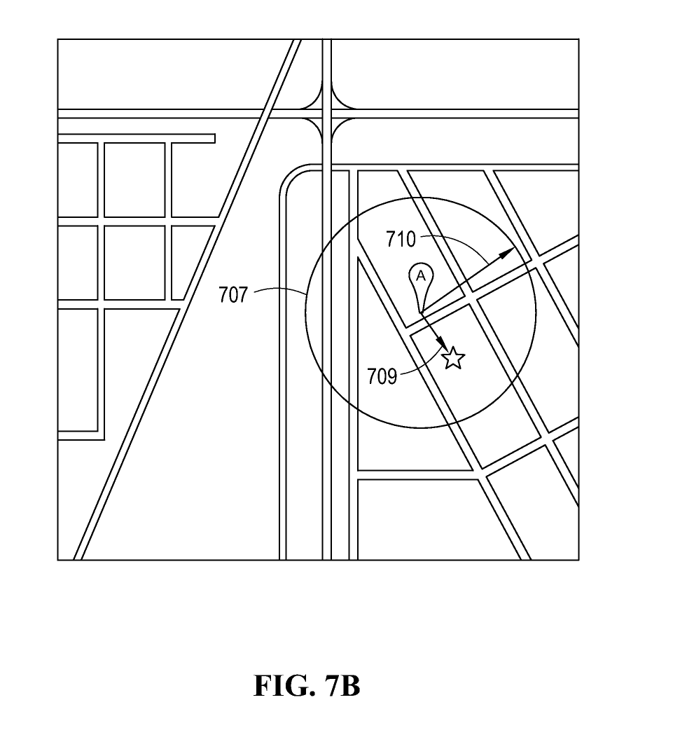

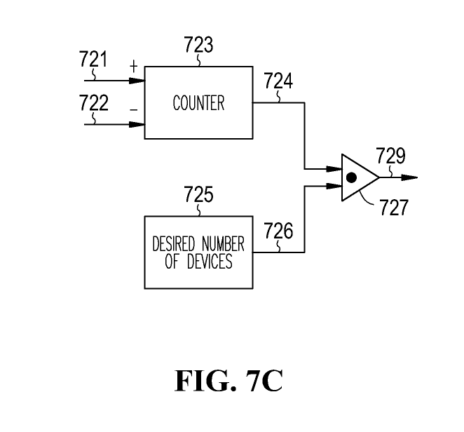

In one embodiment, based on the number of devices within a geographic locale, the location-based incentive application 130 receives a communication from or relating to one or more mobile devices 132 illustrated in illustrated in FIG. 1, or, in some instances, other devices, within that locale. This may be accomplished, in one embodiment, by a GPS system which determines the number of devices within the geographic locale, as discussed more specifically with respect to FIGS. 7A and 7B, below. In some examples, the communication from the device may also include a specification of an item. Based on the number of devices within the given geographic locale, and sometimes based on the specified item on the mobile devices 132, the incentive module 206 may interact with the database server 126 and database 128 to determine and communicate incentives from merchants to the devices.

FIG. 3 is a block diagram illustrating an example embodiment of the location identification module 202. The location of the mobile device 132 can be determined in many ways. For example, the mobile device 132 may be equipped with a Global Positioning System (GPS) device that would allow the device to communicate the coordinates or location of the mobile device 132 to a GPS/triangulation service module 302 in communication with the location identification module 202. In another example, the location of the mobile device 132 may be determined by triangulation using wireless communication towers and/or wireless nodes (e.g. wi-fi hotspots) within wireless signal reach of the mobile device 132. Based on the geographic coordinates, the GPS/triangulation service module 302 can determine the geographic locale of the mobile device 132 after consulting a mapping database (not shown). As mentioned previously, one of ordinary skill in the art will recognize that a similarly operating GPS/triangulation service module 302, or other suitable location technology module, may be located within a separate location service provider that provides user locale results to other businesses, such as the network-based publisher system 102 illustrated in FIG. 1. Furthermore, the general location of the mobile device 132 can be located when the user of the mobile device 132 logs onto a local internet connection, for example, at a hotel or coffee shop. The Internet Protocol address of the network connection at the hotel can be uniquely identified by the location of the hotel.

The location identification module 202 may also include a location input module 306 configured to determine a geographic locale of a mobile device 132 illustrated in FIG. 1 by requesting the user to input an address, city, zip code or other location information on his/her mobile device 132. In one embodiment, the user can select a location from a list of locations or a map on the mobile device 132. For example, a user on the mobile device 132 may input the location of the mobile device 132 via an application or a web browser on the mobile device 132. In another embodiment, the location input module 306 may derive the geographic location of the user by communicating with third party application using respective APIs (application programming interface).

The location identification module 202 may also include a location-dependent search terms module 304. The location of the mobile device 132 illustrated in FIG. 1 can be inferred when the user of the mobile device 132 requests a search on the mobile device 132 using location-dependent search terms. For example, a user may input a search query on his/her mobile device 132 for “Best Japanese Restaurant San Jose.” The location-dependent search term module 304 may query a database (not shown) that can determine the geographic location of the best Japanese restaurant in San Jose. The location-dependent search term module 304 may then infer that the user of the mobile device 132 is within that geographic locale. In one embodiment, the location-dependent search terms module 304 may detect the search query term “San Jose” as a location and infer that the location of the user is San Jose, irrespective of actually running the search.

Another type of location solution, here shown included in the location identification module 202, may include a location tag module 308 configured to determine the geographic locale of the mobile device 132 illustrated in FIG. 1 based on a tag associated with a unique geographic location. The tag may include, for example, a barcode tag (e.g. linear barcode or two dimensional bar code) or a radio frequency identification (RFID) tag that is associated with a unique geographic location. For example, the user of the mobile device 132 may use his/her mobile device 132 to scan the tag placed at a landmark or store where the tag is uniquely associated with the geographic location of the landmark or store. Such a relationship can be stored in a database. The location tag module 308 can then determine the geographic locale of the mobile device 132 based on the tag after consulting the database. As with the GPS system discussed above, one of ordinary skill in the art will recognize that systems performing the same or similar functions to those described above as being in the location identification module 202 can likewise be located at and/or operated by independent service providers who provide the results of the service to other businesses like network-based publisher 102 illustrated in FIG. 1.

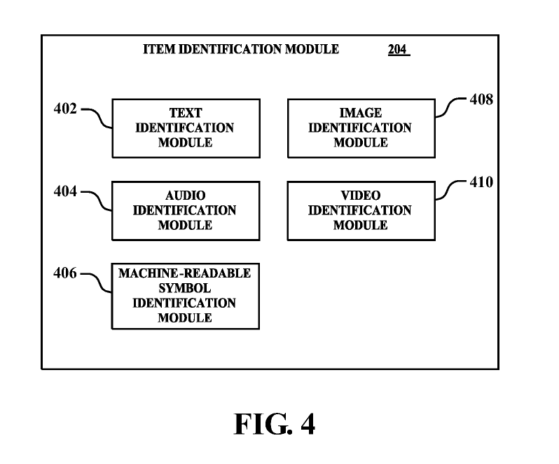

FIG. 4 is a block diagram illustrating an example embodiment of an item identification module 204. The item specified by the user of the mobile device 132 illustrated in FIG. 1 can be determined in many ways including the following examples of modules: a text identification module 402, an audio identification module 404, a machine-readable symbol identification module 406, an image identification module 408, and a video identification module 410.

The text identification module 402 may identify an item or a category of an item specified by the user at the mobile device 132 illustrated in FIG. 1 using text input by the user at the mobile device 132. For example, the user may enter the brand and model number of an item the user wishes to search for at the location of the mobile device 132. The text identification module 402 can then identify the item by comparing the brand and model number of the item with a database containing a catalog of products. In another embodiment, the user can input a category of the item. For example, the user may be interested in not a specific digital camera but any brand of digital camera. As such, the user may specify “digital camera” as a category for searching. The text identification module 402 can then identify items that correspond to the text input by the user. In this case, the text identification module 402 may identify items that match the category of the item input by the user (e.g. all digital cameras).

In another embodiment, the user can enter the barcode or any other type of code associated with an item. The machine-readable symbol module 406 can then identify the item by comparing the barcode with a database containing a catalog of products and their corresponding barcodes.

The audio identification module 404 identifies an item or a category of the item as specified by the user at the mobile device 132 illustrated in FIG. 1 using an audio input from the user of the mobile device 132. For example, the user may speak the brand name and model of an item the user wishes to search for at the location of the mobile device 132. The audio identification module 404 may include a speech recognition system (not shown) that enables the spoken words of the user to be transcribed into text. In another embodiment, the audio identification module 404 may include a song recognition system (not shown) that recognizes the title and author of the song.

The audio identification module 404 can then be used to identify the specified item by comparing the brand and model number of the item transcribed from the audio with a database containing a catalog of products. In another embodiment, the user can speak a category of the item. For example, the user may be interested in not a specific digital camera but any brand of digital camera. As such the user may say “digital camera” to the mobile device 132 illustrated in FIG. 1 as a category for searching. The audio identification module 404 can then identify items that correspond to the audio input by the user. In this case, the text identification module 402 may identify items that match the category of the item as spoken by the user (e.g. “digital camera”).

The machine-readable symbol module 406 may identify an item by having the user scan the bar code or any other machine-readable symbol with his/her mobile device 132 illustrated in FIG. 1 as a machine-readable symbol reader. For example, the mobile device 132 may include an optical device (e.g. a lens) configured to capture an image of a bar code on an item or product. The mobile device 132 may then upload the captured image to the machine-readable symbol module 406. The machine-readable symbol module 406 processes the machine-readable symbol by querying a database of machine-readable symbols to match the machine-readable symbol with a corresponding item or product. The machine-readable symbol module 406 can then identify the item specified by the user of the mobile device 132. Based on the identified item, the machine-readable symbol module 406 can further determine attributes associated with the item. For example, the machine-readable symbol module 406 can determine the category, brand, and other products related or similar to the identified item. Other identifying and descriptive information related to the identified item may be returned by the machine-readable symbol module 406 as well.

The image identification module 408 may identify an item by having the user take a picture of the item with his/her mobile device 132 illustrated in FIG. 1. Mobile devices 132 commonly have an optical lens for capturing pictures. The mobile device 132 may then upload the picture to the image identification module 408. The image identification module 408 analyzes the picture using an image recognition algorithm (not shown) to match the uploaded picture with a corresponding image of an item. The image recognition algorithm consults a database of images and corresponding items to identify the uploaded picture. For example, a user may take a picture of a shoe with his/her mobile device 132. The image identification module 408 recognizes the shoe and identifies its brand and model, among other identifying and descriptive information about the item. In another example, the user may take a picture of a barcode or other item identifier. The image identification module 408 may recognize and decode the barcode contained in the image and identify the brand and model. In certain instances, the image identification module 408 may operate in conjunction with one or more other modules, such as the machine-readable symbol module 406 to perform image recognition and identification. In another embodiment, the image identification module 408 can also determine other products related or similar to the identified item.

The video identification module 410 may be configured to identify an item by having the user take a video of the item with his/her mobile device 132 illustrated in FIG. 1. Mobile devices 132 commonly have an optical lens to capture video. The mobile device 132 may then upload the video (or a portion of the video) to the video identification module 410. The video identification module 410 analyzes the frames of the video using an image recognition algorithm (not shown) to match a frame of the video with a corresponding image of an item. The image recognition algorithm may query a database of images and corresponding items to identify the uploaded video. For example, a user may take a video with his/her mobile device 132 of a shoe worn by someone walking. The video identification module 410 may recognize the shoe and identifies its brand and model, among other identifying and descriptive information about the item. In another embodiment, the video identification module 410 can also determine other products related or similar to the identified item.

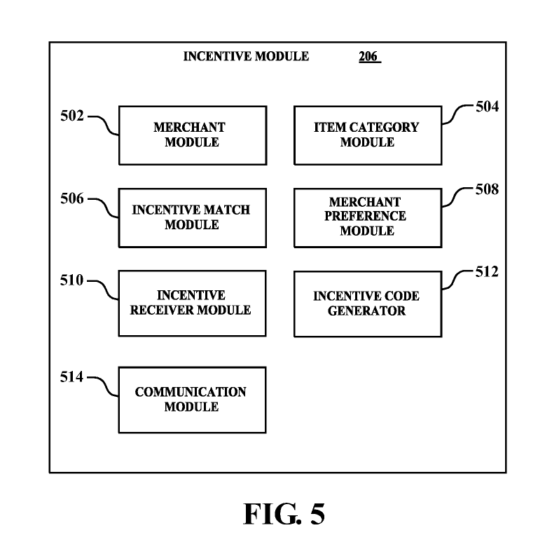

FIG. 5 is a block diagram illustrating an example embodiment of the incentive module 206 that may be used to execute the processes described herein. The incentive module 206 may include a merchant module 502, an item category module 504, an incentive match module 506, a merchant preference module 508, an incentive receiver module 510, an incentive code generator module 512, and a communication module 514.

The merchant module 502 may identify at least one merchant, which may be a local merchant in an embodiment, having at least one incentive based on the number of devices within the geographic locale as determined by the location identification module 202 illustrated in FIG. 2. A local merchant may be a merchant or retailer that is located within the geographic locale, or within a specified distance from it. In one embodiment, the merchant module 502 may identifiy at least one local merchant with at least one such incentive. In other embodiments, the incentive may be on a particular item, but based on both the number of devices within the locale and also the specification of that item on the number of devices within the locale. The number of users within the geographic locale may be specified in the merchant preference module 508.

As mentioned previously, the incentive may be based only on the number of devices within the geographic locale. In embodiments in which the incentive is based on both the number of devices within the locale and also the identification of an item by the devices, the incentive of the local merchant may or may not correspond to the item identified by the user. For example, a local merchant may feature a special sale on shoes while the identified item corresponds to a digital camera. Once all local merchants having incentives are identified based on the number of devices within the geographic locale and on the specified item (using a database of incentives), the incentive match module 506 may filter all local merchants based on the identified item. In the previous example, the local merchant featuring a sale on shoes may be filtered out from the search result.

The item category module 504 may determine a category of the item specified by the user and identified by item identification module 204 illustrated in FIG. 2. For example, the user may specify a particular digital camera. The item category module 504 may determine that the item specified by the user falls into the category of electronics and the subcategory of cameras.

The incentive match module 506 may determine whether the identified item specified by the user corresponds to an item identified in at least one incentive of at least one local merchant as determined by the merchant module 502. For example, a user specifies an item with his/her mobile device 132 illustrated in FIG. 1. The item is identified as a specific digital camera. The item identification module 204 illustrated in FIG. 2 may generate the brand, model number, color, and other attributes of the specified digital camera. The merchant module 502 may identify merchants with incentives based on the number of devices within the locale, and the incentive match module 506 may match local merchants with such incentives (sale or discount) on the specific digital camera.

In another embodiment, the incentive match module 506 may determine whether the category of the item identified by the user corresponds to a category of items as determined by item category module 504 and identified in at least one incentive of at least one local merchant. For example, a user may specify an item with his/her mobile device 132, as illustrated in FIG. 1. The item may be identified as a specific digital camera. The item identification module 204 illustrated in FIG. 2 may generate the brand, model number, color, and other attributes of the specified digital camera. The item category module 504 may determine the category of the identified item: electronics. The merchant module 502 may identify merchants with such incentives based on the number of device within the locale. The incentive match module 506 may match local merchants with such incentives (sale or discount) on electronics or categories related to the digital camera.

The merchant preference module 508 may provide preferences used in the process of determining the given geographic locale. In one embodiment, the merchant preference module 508 may allow a merchant to set or update a distance preference for, in one embodiment, the center and the radius of a circular geographic area within which the number of devices should be located. For example, the merchant may wish to decrease the radius of the distance preference in a downtown area of a city. Conversely, the merchant may wish to increase the radius of the distance preference in a suburban or rural area of a city.

The incentive code generator module 512 may generate a code associated with at least one incentive selected by the merchant. The code may be valid for a predetermined period of time at the merchant. For example, provided there is the desired number of devices in the given area, the merchant may communicate a coupon for a sale to those devices. The incentive code generator module 512 may generate a code associated with the coupon. The code may be communicated to the mobile device 132 illustrated in FIG. 1 of the user. The user may take the code to the corresponding local merchant to redeem the discount. The code can be redeemed at the local merchant by showing or speaking the code to a cashier at the checkout register of the local merchant. The cashier may then enter the code at the checkout register to determine the validity of the code and appropriately apply the discount or promotion. The code may also be redeemed by displaying a machine-readable code such as a bar code on a screen of the mobile device 132. The user may then display the bar code to the cashier at the checkout register who can scan the bar code to determine the validity of the code and appropriately apply the discount or promotion.

In one embodiment, the code may be valid for a predetermined period of time (e.g. one day, one week, etc . . . ). In another embodiment, the generated code may be uniquely associated with the user of the mobile device 132 illustrated in FIG. 1 and may expire immediately upon the user redeeming the coupon.

The communication module 514 may communicate one or more incentives specified by the merchant when the desired number of devices is within the geographic area. In another embodiment, the communication module 514 may communicate one or more incentives of the category of the item identified by the desired number of devices within the geographic area. The list may also include a list of recommended merchants having an incentive based on the number of users in the geographic area, or on items similar to the item identified by the desired number of devices within the geographic area. These merchants may be located beyond the preset distance radius.

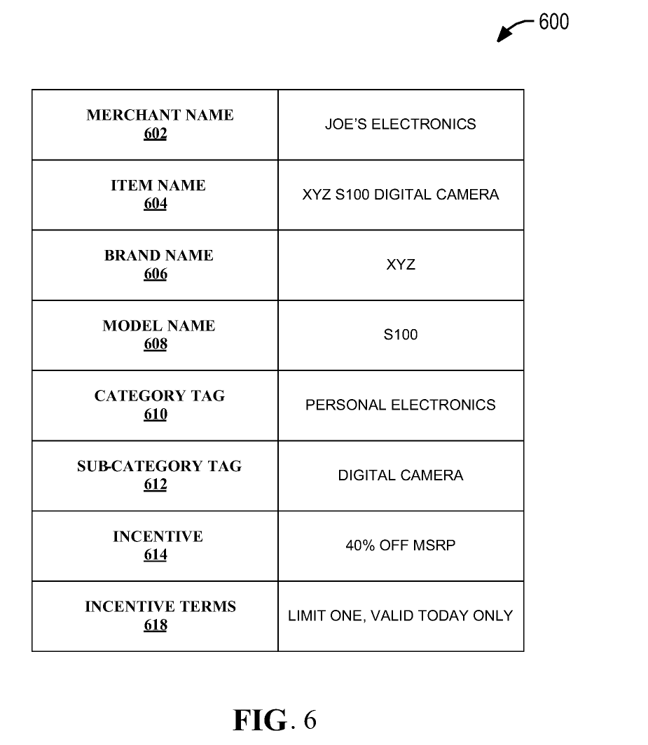

The incentive receiver module 510 may collect attributes of incentives from merchants and stores the attributes of the incentives in an incentive database. An example of a data structure of the incentive database is further described in FIG. 6.

FIG. 6 is a block diagram illustrating attributes of an example of a data structure 600 of an incentive. In one embodiment, the data structure 600 of the incentive database may include attributes of the incentives for an item. For example, the attributes may include a merchant name 602 that names the merchant, an item name 604 that names the item, a brand name 606 of the item, a model name 608 of the item, a category tag 610,associated with the item a sub-category tag 612 further associated with the item, an incentive 614 associated with the item, and an incentive terms 618 associated with the item.

The merchant name 602 attribute may include the name of the local merchant (e.g. Joe's Electronic Shop). The item name 604 attribute may include the name of an item (e.g. digital camera XYZ D001). The brand name 606 attribute may include the brand name of the item (e.g. brand XYZ). The model name 608 attribute may include the model number of the item (e.g. D001). The category tag 610 attribute may include category metadata associated with the item (e.g. personal electronics). The sub-category tag 612 attribute may include sub-category metadata associated with the item (e.g. digital camera). The incentive 614 attribute may include the sale or discount associated with the item (e.g. 40% all digital cameras, or 20% all brand XYZ digital cameras). The incentive terms 618 attribute may include the terms of the sale or discount associated with the item (e.g. discount expires on xx/xx/xxxx, discount expires one week from today, or discount valid today only).

In the cases described above, each of the attributes may be associated with an indicator (e.g., threshold) of the number of devices within a given area that justifies offering the incentive may be included. This number may be used with, or in conjunction with, merchant preference module 508 illustrated in FIG. 5.

FIG. 7A shows a simplified diagram of a GPS locating system 700. The GPS locating system 700 is shown to include a GPS satellite 701, a smart phone 703, and a merchant database 713. The smart phone 703 may be the electronic mobile device 132 discussed with reference to FIG. 1. The merchant database 713 may be a local database maintained by an area chamber of commerce, the information storage databases 231 discussed above (see FIG. 2), or a merchant database 713 such as Website Yellow Pages®, maintained by Platinum Advertising LLC of Appleton, Wis., USA.

In various ones of the example embodiments discussed, the end user of the mobile device 132 illustrated in FIG. 1 is either automatically directed to, or given the option of being directed to, a local merchant to view or purchase the selected items of interest. The GPS locating system 700 can be used to make a determination of the local merchant. The GPS satellite 701 may track the smart phone 703 by an integrated circuit (i.e., a GPS receiver) embedded into most cellular phones for the past several years. By means known to those of ordinary skill in the art, a signal is received by the GPS satellite 701 from the smart phone 703. (The signal may be received indirectly through a cellular phone tower.) The GPS satellite 701 may determine a location of the smart phone 703 as indicated on a virtual map 707. Within several meters of accuracy, a position 709 of the smart phone 703 may be indicated on the virtual map 707 and transmitted or otherwise transferred to the smart phone 703 through a return transmission path 711. The smart phone 703 may respond by transmitting the position 709 to the merchant database 713 through a bi-directional communication channel 715. A determination of nearest local merchants can then be determined (by, for example, either the smart phone 703 of the merchant database 713). **no mention of callout 705.

In other example embodiments, a determination of position may be made by other means. For example, if the end user is located within a shopping mall, various networks within the mall may be accessed to determine a location of the electronic device of the end user.

FIG. 7B illustrates one embodiment for determining the number of users within a given geographic locale. For example, the merchant may configure the locale to the GPS service provider by means of the radius, 710, which determines a specific circle around a given merchant, or other point of interest. The merchant can, for example, using merchant preference module 508 illustrated in FIG. 5, provide to the GPS service provider the number of devices desired to be in a geographic locale and the identity of the geographic locale, by a certain distance, e.g., a radius, from the center of a circle circumscribing a geographic area, in one example. When the GPS locating system 700 determines that a cell phone or other mobile device 703 illustrated in FIG. 7A (or non-mobile device, in some instances) is at a given point the system can, using separately known technology, determine whether that point is within the given radius of a circle that circumscribes the locale identified by the merchant.

FIG. 7C illustrates an apparatus useful in determining the number of devices in a given geometrical local. Counter 723, having input over line 721, and register 725, are connected by buses 724 and 726, respectively, to comparator 727. The output of comparator 727 is seen on line 729. Comparator 727 is here represented by a single AND gate for ease of illustration. Those of ordinary skill in the art will understand that in practice the number of AND gates and other components of the comparator 727 will vary depending on the number of data lines on which the predetermined number may be represented in a given design. In operation, a signal may be provided over line 721 to counter 723 to increment the counter by one. This may be done consistently as cell phones or other devices are detected by the GPS system as being within, or when entering, the locale and the counter is incremented so as to count the signals input over line 721. When a device is detected as leaving the area, as may sometimes be the case, the counter may be decremented by the GPS system by providing a signal over line 722 to decrement the counter by one count, in an effort to maintain a consistent count of the devices within the geographic locale. Register 725 may have stored therein a number supplied by the merchant, for example, to merchant preference module 508 in FIG. 5. The number may indicate the minimum number of devices within the geographic locale, for which the merchant will provide a deal or incentive to the users of the devices. This number may be set into register 725 by merchant preference module 508. The output 724 of the counter is compared to the predetermined number over line 726. When the number of devices within the geographic locale reaches the predetermined number desired by the merchant, the output 729 of the comparator 727 can be provided to the merchant as indicating that the desired number of devices is within the locale. The merchant may then determine that there is a deal for the users of the devices and provide the users with information relating to the deal as more fully described below. As mentioned above, the system may also determine devices within the geographic area that also identify an item specified by the merchant. This may be accomplished by, before entering FIG. 7B, filtering out devices that identify the specified item and then providing signals representing the remaining devices to line 721 or 722, depending on whether the device enters or leaves the geographic locale. When the number of devices that identify a specified item reaches the desired number, according to the operation explained above in this paragraph. The output 729 could again be sent to the merchant for the reason described above.

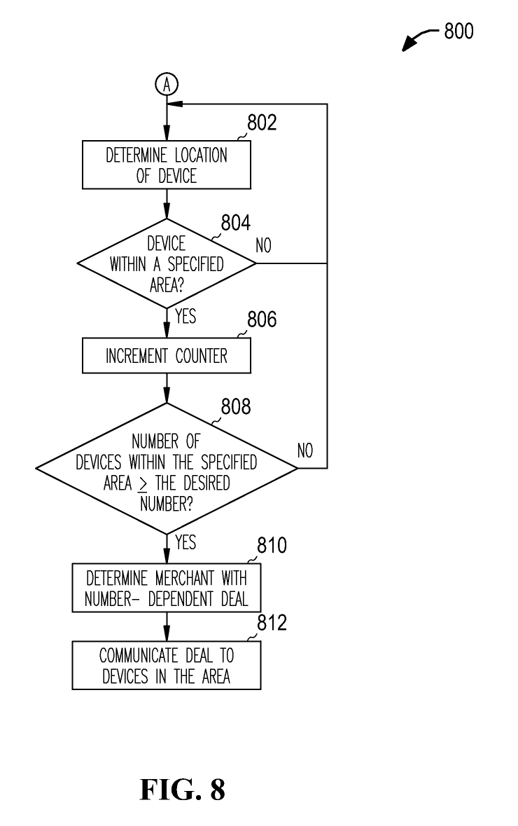

FIG. 8 is a flow chart of an example method 800, as identified above. The method 800 illustrated at FIG. 8 depicts activity using location identification module 202, as illustrated in FIG. 2. As previously mentioned, those of ordinary skill in the art will understand that an external location identification service provider, for example an external GPS system, could be used as well. At operation 802, the location identification module 202 of the location-based incentive application 130, as illustrated in FIG. 1, may determine the geographic locale of a device. At decision operation 804, the location identification module 202 may determine whether the device is within the desired geographic area. If it is not, the NO leg of the decision begins the method again at operation 802. If the decision is YES, the counter 723, as illustrated in FIG. 7B, may be incremented at operation 806. At decision operation 808, the number in counter 723 is sent over output 724 to comparator 727 illustrated in FIG. 7B. The desired number in register 725 may be sent over line 726 illustrated in FIG. 7B to comparator 727. If the number in the counter 723 at least equals the desired number, then a signal is activated on output 729 illustrated in FIG. 7B, indicated by the YES decision at decision block 808. A merchant with a number-dependent deal is determined at 810, which could also be done before step 802, or at any steps before or including step 810, and the number, and the identity of the devices may be sent to the appropriate merchant or merchants over line 729. The merchant(s) may communicate the corresponding deal or incentive to the devices within the geographic area. Alternatively, if it is desired to determine whether the number of devices within the desired area also identify a specific item which may be provided by merchant preference module 508 illustrated in FIG. 5, then a comparison can be made after step 804 to compare the specified item with any item identified by the device in question, and the method continues as described above, except that instead of any merchant deal, a deal with respect to the identified specific item and the number of devices is the deal the merchant may send to the devices when the desired number of such devices is located within the desired geographic area. A method for determining such types of deals is explained above and also in detail in U.S. patent application Ser. No. 3/050,769 discussed above.

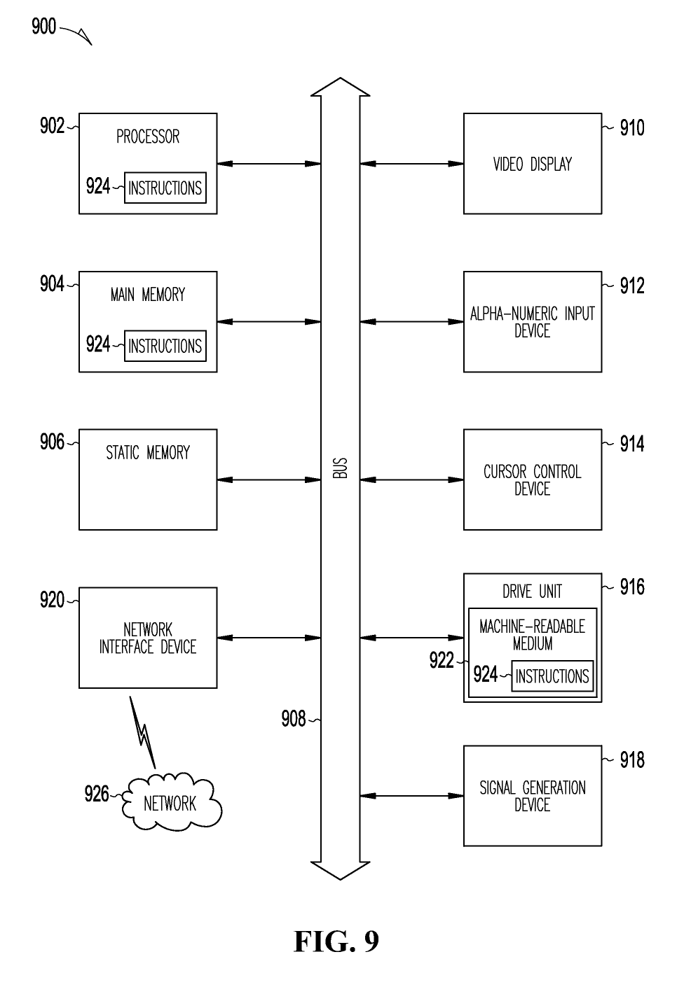

FIG. 9 shows a diagrammatic representation of machine in the example form of a computer system 900 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920 utilizing any one of a number of well-known transfer protocols (e.g., HTTP).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present embodiments, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a processor-implemented location information receiver module for receiving location information from a location determining system configured to determine a number of devices within a geographic locale, the location information comprising a signal indicating when a predetermined number of devices is located within the geographic locale; and
a processor-implemented incentive module configured to offer an incentive based on the number of devices within the geographic locale.

2. The system of claim 1 wherein the processor-implemented incentive module further comprises:
a processor-implemented merchant module configured to identify at least one merchant with at least one incentive for at least one item, the incentive based on the number of devices located within the geographic locale; and
a processor-implemented communication module configured to communicate the at least one incentive of the at least one item over a network.

3. The system of claim 1 wherein at least one merchant is located within the geographic locale.

4. The system of claim 1 wherein the processor-implemented incentive module further comprises:
a processor-implemented incentive code module configured to communicate a code associated with at least one incentive to a plurality of devices within the geographic locale, wherein the code is valid for a predetermined period of time.

5. The system of claim 1 wherein the processor-implemented location information receiver module further comprises a processor-implemented receiver for receiving information from one of the group consisting of a triangulation service, a global positioning service (GPS), a receiver system configured to determine the location of a device based on a location-dependent search term input at the device, and a tag system configured to determine the location of the device based on a tag from the device, the tag associated with a geographic location.

6. The system of claim 1 wherein the system further comprises:
a processor-implemented item identification module configured to identify an item based on at least one of the group consisting of
a text input to at least one of the number of devices;
an audio input from at least one of the number of devices;
a machine-readable symbol scanned by the at least one of the number of devices;
an image taken by at least one of the number of devices; and
a video taken by at least one of the number of devices.

7. The system of claim 1 wherein the processor-implemented incentive module further comprises:
a processor-implemented incentive receiver module configured to receive attributes of incentives and store the attributes of the incentives in a database,
wherein the attributes comprise at least one of a name attribute of a merchant, a name attribute of an item, a brand attribute of an item, a model attribute of an item, a category tag of an item, a sub-category tag of an item, a financial promotion attribute of an item, and a financial promotion term attribute of an item.

8. A method, comprising:
using a computer processor, receiving location information from a location determining system configured to determine the number of devices within a geographic locale, the location information comprising a signal indicating when a predetermined number of devices is located within the geographic locale; and
in response to the signal, transmitting an incentive from at least one merchant based on the number of devices within the geographic locale.

9. The method of claim 8 further comprising:
identifying at least one merchant with at least one incentive for at least one item based on the number of devices located within the geographic locale; and
communicating the at least one incentive over a network.

10. The method of claim 8 wherein the at least one merchant is located within the geographic locale.

11. The method of claim 8 further comprising communicating a code associated with the at least one incentive, wherein the code is valid for a predetermined period of time.

12. The method of claim 8 further comprising receiving information from a system from the group of systems consisting of a triangulation service, a global positioning service (GPS), a location-dependent search term receiver system configured to determine the location of the device based on a location-dependent search term input at a device, and a tag module system configured to determine the location of a device based on a tag from the device, the tag associated with a geographic location.

13. The method of claim 8 further comprising:
identifying an item based on at least one of the group consisting of
a text input at a device within the geographic locale;
an audio input from a device within the geographic locale;
a machine-readable symbol scanned by a device within the geographic locale;
an image taken by a device within the geographic locale; and
a video taken by a device within the geographic locale.

14. The method of claim 8 further comprising:
receiving attributes of incentives from the at least one merchant and store the attributes in a database,
wherein the attributes comprise at least one of a name attribute of a merchant, a name attribute of an item, a brand attribute of an item, a model attribute of an item, a category tag of an item, a sub-category tag of an item, a financial promotion attribute of an item, and a financial promotion term attribute of the item.

15. A machine readable storage device having a set of instructions which, when executed by the machine, cause the machine to execute the following operations:
receiving location information from a location determining system configured to determine the number of devices within a geographic locale, the location information comprising a signal indicating when a predetermined number of devices is located within the geographic locale; and
in response to the signal, offering an incentive from at least one merchant based on the number of devices within the geographic locale.

16. The machine readable storage device of claim 15, the operations further comprising:
identifying at least one merchant with at least one incentive for at least one item based on the number of devices located within the geographic locale; and
communicating the at least one incentive of the at least one item over a network.

17. The machine readable storage device of claim 15 wherein the at least one merchant is located within the geographic locale.

18. The machine readable storage device of claim 15, the operations further comprising communicating a code associated with the incentive to a mobile device, wherein the code is valid for a predetermined period of time.

19. The machine readable storage device of claim 15, the operations further comprising receiving information from the group of systems consisting of a triangulation service, a global positioning service (GPS), a location-dependent search term receiver system configured to determine the location of a device based on a location-dependent search term input at the device, and a tag module system configured to determine the location of a device based on a tag from the device, the tag associated with a geographic location.

20. The machine readable storage device of claim 15 wherein the operations further comprise:
identifying an item based on at least one of the group consisting of
a text input from a device within the geographic locale;
an audio input from a device within at the geographic locale;
a machine-readable symbol scanned by at least one device within the geographic locale;
an image taken by a device within the geographic locale; and
a video taken by a device within the geographic locale.

21. The machine readable storage device of claim 15, the operations further comprising:
receiving attributes of incentives from the at least one merchant and storing the attributes in a database,
wherein the attributes comprise at least one of a name attribute of a merchant, a name attribute of an item, a brand attribute of an item, a model attribute of an item, a category tag of an item, a sub-category tag of an item, a financial promotion attribute of an item, and a financial promotion term attribute of the item.

22. The system of claim 1 wherein the incentive is also based on an item specified by the devices.

23. The method of claim 8 wherein the incentive is also based on an item specified by the devices.

24. The machine-readable storage device of claim 15 wherein the incentive is also based on an item specified by the devices.
